(19) United States
(12) Patent Application Publication
(10) Pub. No.: US 2006/0144229 A1
(43) Pub. Date: Jul. 6, 2006

(54) Apparatus and method for pressurising biogas in a gas washer

(76) Inventor: Erkki Kalmari, Leppavesi (FI)

Correspondence Address: YOUNG & THOMPSON, 745 SOUTH 23RD STREET, 2ND FLOOR, ARLINGTON, VA, 22202, US

(21) Appl. No.: 10/525,768

(22) PCT Filed: Aug. 30, 2002
(86) PCT No.: PCT/FI02/00701

§ 371 Date: Sep. 12, 2005

(51) Int. Cl. B01D 47/00

(52) U.S. Cl. 95/149

(57) ABSTRACT

A pressurization apparatus (201) for biogas includes a biogas inlet pipe (211) having at least a biogas feeding element (213), a biogas outlet pipe (221) having at least a cut-off element (222, 223), a washing water inlet pipe (231) having at least a washing water pressurization device (232), a washing water outlet pipe (241) having at least a cut-off valve (242), the apparatus being controlled either manually or automatically.

### BACKGROUND OF THE INVENTION

The invention relates to a pressurization apparatus for biogas.

Biogas may be produced for instance from agricultural and communal waste waters and sludges by means of separate biogas reactors. It may also be recovered e.g. from landfills where decomposing organic wastes are disposed of.

In general, biogas comprises from 30 to 50% by volume of carbon dioxide, and accordingly, even a partial removal thereof significantly reduces for instance the space needed for storing the gas. Also the effectivity of biogas combustion is improved by lowering the carbon dioxide content thereof. Moreover, biogas commonly contains other compounds such as hydrogen sulphide complicating the use thereof, or causing e.g. corrosion.

One obstacle in the use of biogas is generally its low production or recovery pressure. It may be used on site for instance in boilers and aggregates, whereas its use in vehicles is often uneconomical due to high pressurization and storage costs.

Biogas is pressurized e.g. by means of high pressure compressors, such as water ring compressors. It is also possible to pressurize and purify biogas for instance with column washers that increase the pressure of biogas to about 10 to 40 at (gauge). Drawbacks of these apparatuses include the fact that they are either physically large or technically extremely complicated. Accordingly, such apparatuses are very expensive particularly in cases where pressures of 100 to 200 at (gauge) are sought.

### GENERAL DESCRIPTION OF THE INVENTION

Now a pressurization apparatus for biogas has been found, said apparatus being technically particularly simple and compact.

To achieve this object, the invention is characterized by facts presented in the independent claims. The other claims disclose some preferable embodiments of the invention.

Biogas may not only be pressurized but also purified by means of the pressurization apparatus of the invention using for instance water as the washing liquid. If necessary, compounds or agents that intensify the purification may be added to said water.

The pressurization apparatus of the invention comprises at least a biogas inlet pipe provided with a pressurization device, a biogas outlet pipe, an inlet pipe for washing water provided with a pressurization device, as well as an outlet pipe for washing water. The pressurization apparatus is further equipped with cut-off valves and one-way valves necessary for the operation thereof. The operation of the pressurization apparatus is controlled for instance with a limit switch or a balance.

Preferably, a unit for removing carbon dioxide may be connected to said washing water outlet pipe.

The biogas inlet pipe may preferably be provided with a one-way valve preventing biogas from flowing out of the pressurization apparatus. This one-way valve is preferably placed as close to the pressurization apparatus as possible. Said one-way valve controls the biogas flow. If the pressure of the pressurization apparatus is lower than that of the inlet pipe, biogas will flow to the pressurization apparatus, whereas the biogas flow is stopped in situations where the pressure of the pressurization apparatus is higher than that of the inlet pipe.

The removal of biogas from the pressurization apparatus may for instance be carried out by providing the outlet pipe with a cut-off device such as a cut-off valve and/or one-way valve for biogas. The operation thereof is adjusted to and/or controlled according to the washing water and feed.

Pressurized washing water is preferably passed through a nebulizer into the pressurization apparatus containing biogas. As the water level rises, biogas washed in the pressurization apparatus starts to flow out of the pressurization apparatus under control of the cut-off device. As the water level reaches the upper limit in the container or outlet pipe, the washing water feed is stopped and the valve of the washing water outlet pipe is opened. As the water level is lowered, biogas is either fed or it flows through the one-way valve to the pressurization apparatus under control of the set values of said one-way valve. The valve of the washing water outlet pipe is closed as the water level reaches the set lower limit. The biogas feed to the pressurization apparatus is stopped, or biogas may flow to the pressurization apparatus under control of an optional one-way valve to reach the desired control value. Then the above cycle is repeated.

The nebulizer is preferably placed in the upper part of the pressurization apparatus to always pass the biogas to be purified through the spray of the nebulizer, thus assuring that only purified biogas is leaving the pressurization apparatus.

Biogas may preferably flow to the pressurization apparatus during the lowering of the water level. It may also flow to the pressurization apparatus after the lowering and/or rising of the water level has stopped, or as the water level is rising.

Washing water is preferably passed from the outlet pipe thereof to the pressurization device of the inlet pipe and to the nebulizer of the washing water. Washing water may be replaced partially or totally with fresh washing water. The washing water pipes may for instance be provided with a device for dispensing a detergent. In addition, the outlet pipe for washing water is preferably equipped with a unit for removing carbon dioxide.

The pressurized and purified biogas leaving the pressurization apparatus may be passed through one or several drying device(s) e.g. to pressurized tanks or biogas containers.

The apparatus used to purify and pressurize biogas is technically very simple, and moreover, the use thereof is economical and safe. It is preferable to feed biogas at a pressure of 1 to 100 at, such as 1 to 50 at, 1 to 10 at, 5 to 15 at, 5 to 50 at or 50 to 100 at (gauge) to the pressurization apparatus where it is pressurized to a pressure of 10 to 600 at, such as 10 to 50 at, 50 to 100 at, 100 to 300 at, 100 to 200 at, or 200 to 600 at (gauge).

The pressurization apparatus of the invention may only have two pumps. Both of them may preferably be serially produced gas compressors and water compressors that are already currently used in the industry or agriculture. This significantly contributes to the feasibility of the invention.

In the pressurization apparatus of the invention, preferably two water compressors may be used to feed said washing water. Relative to said washing water, one of the pumps may then be a powerful low pressure pump, the other pump being less powerful high pressure pump. Then, more than half of the pressure container may be quickly filled by means of the low pressure pump, and thereafter the rest of the container is filled against higher counterpressure with the higher pressure pump. This solution makes the use of the apparatus substantially quicker and more effective compared to an apparatus with a single water pump.

The maintenance of the apparatus of the invention is also favourable. The maintenance and repair costs of serially produced devices are usually low.

It is thus possible to pressurize biogas preferably to a pressure of 100 to 600 at (gauge) by means of an apparatus that is technically very simple, and simultaneously remove therefrom carbon dioxide, particles and hydrogen sulphide. Since the solubility of e.g. carbon dioxide depends on the pressure of the washing water used, high carbon dioxide removal is attained with the apparatus of the invention due to high pressures used.

It is also preferable to use unpurified pressurized biogas in the pressurization apparatus to displace washing water, since this prevents the carbon dioxide of the washing water from being released in the pressurization apparatus. Carbon dioxide may be removed from washing water in the carbon dioxide removal unit connected to the outlet pipe where the pressure of the washing water is lowered to a value near the ambient pressure, that is to 0.5 to 1.5 at (gauge). Carbon dioxide is thus released quickly and effectively from the washing water. Preferably, carbon dioxide depleted washing water may again be recycled to the pressurization device of washing water.

The pressurization apparatus may be designed in different sizes. It may be built as small units for farms, or as large units for instance for waste water treatment plants. Also embodiments that may be transferred are possible, allowing for the pressurization of biogas from agricultural gas supplies, if necessary.

The apparatus of the invention may be controlled either with an automatic and/or manually operated control means to carry out the cycle necessary for the pressurization.

### DETAILED DESCRIPTION OF THE INVENTION

Some embodiments of the invention are now discussed in detail with reference to the appended drawings.

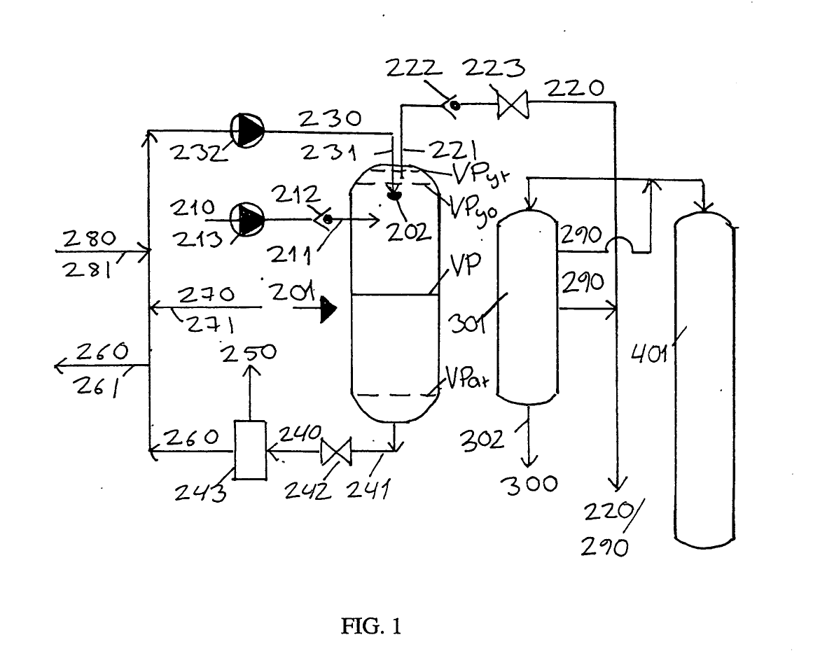

FIG. 1 shows a pressurization apparatus used to pressurize biogas.

In FIG. 1, a pressurization apparatus 201 used to purify biogas 210 comprises a biogas inlet pipe 211, a biogas outlet pipe 221, washing water inlet pipe 231 and washing water outlet pipe 241. The biogas inlet pipe 211 is provided with a one-way valve 212 and a biogas feeding means 213. The biogas outlet pipe 221 is provided with a one-way valve 222 and a cut-off valve 223 acting as the cut-off means of biogas, as well as a drying means 300 for biogas. The washing water inlet pipe 231 is connected to a water compressor 232 and a nebulized 202 placed inside the pressurization apparatus 201. The washing water outlet pipe 241 is equipped with a cut-off valve 242 and a carbon dioxide removal unit 243.

With the apparatus of FIG. 1, biogas for instance from a biogas reactor and a biogas reservoir may be pressurized and purified according to the following cycle:
pressurized washing water 230 is fed through the nebulizer 202 of the inlet pipe 231 to the pressurization apparatus 201 containing biogas 210
the water level VP in the pressurization apparatus 201 having reached the upper control limit VP_{YO}, the cut-off valve 223 of the biogas outlet pipe 221 is opened thus causing purified biogas 220 to flow into the biogas outlet pipe 220
the water level VP in the pressurization apparatus 201 having reached the upper limit VP_{YR}, the cut-off valve 242 of the washing water outlet pipe 241 is opened
as the pressure is lowered, pressurized biogas 210 flows through the biogas inlet pipe 211
the water level VP in the pressurization apparatus 201 having reached the lower limit VP_{AR}, the cut-off valve 242 of the washing water outlet pipe 241 is closed.

As the pressure in the pressurization apparatus 201 rises, the flow of biogas 210 from the biogas inlet pipe 211 stops. The one-way valve 212 of the biogas inlet pipe 211 controls the flow of biogas 210 during the cycle.

As the water level VP in the pressurization apparatus 201 has reached the upper limit VP_{YR}, the feed of said washing water may be stopped and the cut-off valve 233 of the biogas outlet pipe 211 is closed, and then the cut-off valve 242 of the washing water outlet pipe 241 is opened. Also, as the water level VP in the pressurization apparatus 201 has reached the upper limit VP_{YR}, it is also possible to continue with the feed of washing water 230, closing the cut-off valve 223 of the biogas outlet pipe 221, and thereafter opening the the cut-off valve 242 of the washing water outlet pipe 241. This procedure is possible for instance in situations where the outlet pipe 241 and the corresponding cut-off valve 242 are sufficiently large to remove the washing water 230 accumulated in the pressurization apparatus.

Washing water 240 from the outlet pipe 241 is removed and passed to the carbon dioxide removal unit 243 where carbon dioxide 250 contained in the washing water is released as the pressure is lowered. Then the purified, or fresh washing water 260 is passed to the pressurization compressor 231. On the other hand, the purified washing water 260 may be added with fresh washing water 270 through a pipe 271 and a detergent 280 through a pipe 281. The recycled washing water may also be replaced totally with fresh washing water 270.

1-14. (canceled)

15. A pressurization apparatus for biogas, where said pressurization apparatus for pressurizing biogas comprises:
a biogas inlet pipe having at least a biogas feeding means,
a biogas outlet pipe having at least a biogas cut-off means,
a washing water inlet pipe having at least a washing water pressurization device,
a washing water outlet pipe having at least a cut-off valve,
and is operated according to the following cycle:
pressurized washing water is fed to the pressurization apparatus containing biogas using said washing water pressurization device of said washing water inlet pipe,
purified biogas is passed through said cut-off means of said biogas outlet pipe,
the water level VP in the pressurization apparatus having reached the upper limit VPYR, the cut-off valve of said washing water outlet pipe is opened,
pressurized biogas is passed to said pressurization apparatus through said biogas inlet pipe,
the water level VP in the pressurization apparatus having reached the lower limit VPAR, the cut-off valve of said washing water outlet pipe is closed.

16. Pressurization apparatus according to claim 15, where said biogas inlet pipe comprises a one-way valve to control the flow of said biogas.

17. Pressurization apparatus according to claim 15, where biogas is fed with said biogas feeding means at a pressure of 1 to 100 at (gauge).

18. Pressurization apparatus according to claim 15, where washing water is fed with said washing water pressurization device at a pressure of 10 to 600 at (gauge).

19. Pressurization apparatus according to claim 15, where a carbon dioxide removal unit is connected to said pressurization apparatus.

20. Pressurization apparatus according to claim 15, where said pressurization apparatus comprises one or more nebulizers for washing water.

21. Pressurization apparatus according to claim 15, where said pressurization apparatus comprises two or more washing water pressurization devices.

22. Pressurization apparatus according to claim 15, where one or more dryers for pressurized biogas is (are) connected to said pressurization apparatus.

23. Pressurization apparatus according to claim 15, where the biogas inlet pipe comprises a one-way valve.

24. Pressurization apparatus according to claim 15, where one or more pressure tanks for storage of said pressurized biogas is (are) connected to said pressurization apparatus.

25. A method for pressurizing biogas, where biogas is pressurized by means of a pressurization apparatus comprising:
a biogas inlet pipe having at least a biogas feeding means,
a biogas outlet pipe having at least a cut-off means,
a washing water inlet pipe having at least a washing water pressurization device,
a washing water outlet pipe having at least a cut-off valve,
said apparatus being operated according to the following cycle:
pressurized washing water is fed to the pressurization apparatus containing biogas using said washing water pressurization device,
at least as the water level VP is lowered, purified biogas is passed through said cut-off means of said biogas outlet pipe,
the water level VP in the pressurization apparatus having reached the upper limit VPYR, the cut-off valve of said washing water outlet pipe is opened,
pressurized biogas is passed to said pressurization apparatus through said biogas inlet pipe,
the water level VP in the pressurization apparatus having reached the lower limit VPAR, the cut-off valve of said washing water outlet pipe is closed.

26. Method according to claim 25, where the feed of washing water is stopped as the water level VP has reached the upper limit VPYR.

27. Method according to claims 25, where washing water is fed with said washing water pressurization device at a pressure of 10 to 600 at (gauge).

28. Method for constructing a pressurization apparatus for biogas, where a pressurization apparatus is provided with:
a biogas inlet pipe having at least a biogas feeding means,
a biogas outlet pipe having at least a biogas cut-off means,
a washing water inlet pipe having at least a washing water pressurization device,
a washing water outlet pipe having at least a cut-off valve,
manually operated and/or automatic control device to control said pressurization apparatus according to the method of claim 25.
